(19) United States
(12) Patent Application Publication
(10) Pub. No.: US 2018/0128783 A1
(43) Pub. Date: May 10, 2018

(54) Apparatus for Monitoring the Condition of a Device and Device with such an Apparatus and Method for Condition Monitoring

(71) Applicant: Robert Bosch GmbH, Stuttgart (DE)

(72) Inventors: Ulrich Bittner, Rottenburg (DE); Wilfried Eichner, Wildberg (DE)

(21) Appl. No.: 15/798,629

(22) Filed: Oct. 31, 2017

(30) Foreign Application Priority Data
Nov. 10, 2016 (DE) 10 2016 222 069.1

(51) Int. Cl. G01N 29/14; H04R 29/00; H04R 1/40

(52) U.S. Cl. CPC G01N 29/14; G01M 13/045; H04R 1/406; H04R 29/00

(57) ABSTRACT

An apparatus for airborne-sound-based condition monitoring of a device includes at least one microphone assigned to each component of a plurality of components of the device that is to be monitored.

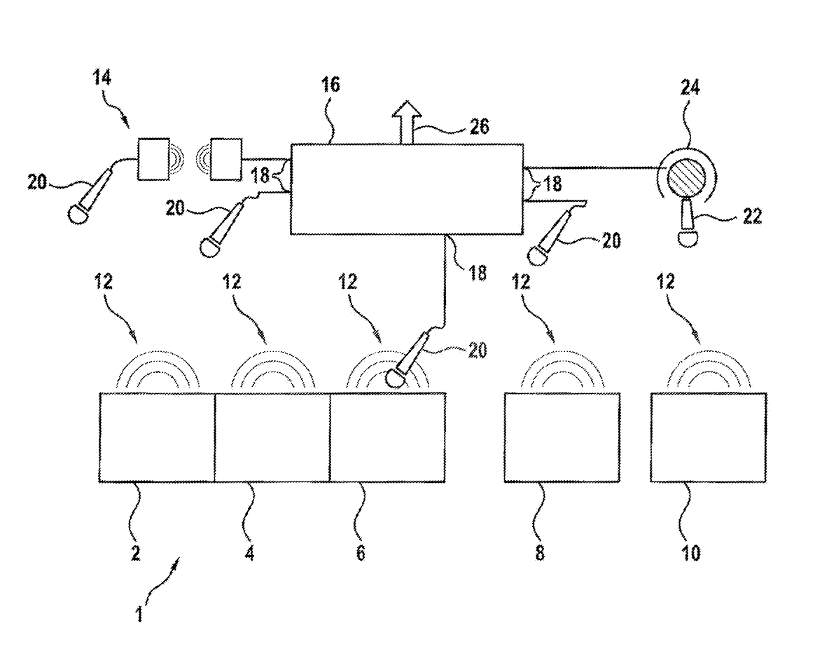

This application claims priority under 35 U.S.C. § 119 to patent application no. DE 10 2016 222 069.1, filed on Nov. 10, 2016 in Germany, the disclosure of which is incorporated herein by reference in its entirety.

The disclosure relates to an apparatus for airborne-sound-based condition monitoring of devices, a device with such an apparatus, and a corresponding method. In the context of this document, device refers to a system (e.g. a mobile working machine or its hydrostatic powertrain) or a machine (e.g. a hydrostatic displacement unit).

### BACKGROUND

Condition monitoring systems from the prior art are used to monitor devices. Vibrations or noises that indicate faulty functioning are determined and evaluated for this purpose.

A hydrostatic pump is disclosed in document D 10 2014 217 185 A1, to the housing of which a sound sensor is fastened. Structure-borne-sound-based apparatus for condition monitoring of machines of this sort are often problematic in terms of the installation space. Threads or the like must be provided on the housing; this is often done through reworking, whereby the risk of damage to the machine arises. The effort and cost of mounting structure-borne-sound-based apparatus is high, and accessibility is often poor. The ambient conditions are often unfavorable for the device, e.g. due to waste heat and vibration of the machine.

The selection of the sensors for the structure-borne sound must always be matched to the application (amplitude and frequency ranges), since otherwise the sensors are easily overdriven, as a result of which the signals are unusable.

Furthermore, methods and apparatuses for condition monitoring that are based on airborne sound, and which therefore comprise a microphone, are known. Such apparatuses, including their microphone, can be arranged at a distance from the device to be monitored. They can be applied flexibly, and can be retrofitted to devices without changing or modifying them.

Document DE 101 00 444 A1 discloses an apparatus in which, in parallel with a vibration analysis of a device to be monitored, an analysis based on airborne sound is also carried out.

A condition monitoring system is described in DE 10 2004 029 356 A1 in which, instead of an image acquisition unit, a sound acquisition unit, which is used to acquire acoustic signals generated by an installation, is also described as an alternative.

WO 00/03459 discloses an airborne-sound-based condition monitoring system for rotating and non-rotating devices and of industrial processes by means of microphones. In a training mode, an acoustic signature of the device to be monitored is stored when it is established that the device is working normally. In an operating mode, the current measurements are compared with this acoustic signature.

An airborne-sound-based condition monitoring system for consumer devices by means of microphones is described in US 2011/0125300 A1. A computer generates a current so-called acoustic fingerprint, and compares this with an ideal acoustic fingerprint.

Airborne sound sensors with microphone and integrated signal processing (microcontroller), which permit deterministic or machine-learning-based recognition (as software packet DLLs), are illustrated on the Internet at schallsensor.de. Panel PCs for configuration and operation of the airborne sound sensors are, furthermore, disclosed. These solutions are expensive special applications with restricted properties.

Particularly disadvantageous with such apparatuses for airborne-sound-based condition monitoring is that they are restricted to one sound source.

### SUMMARY

In contrast, the disclosure is based on the provision of an apparatus for condition monitoring and a condition-monitored device and a method for condition monitoring, wherein several different positions or components of a device at a distance from one another can be monitored.

This object is achieved, in terms of the apparatus, by the features disclosed herein, and in terms of the device disclosed herein, and in terms of the method disclosed herein.

The claimed apparatus for airborne-sound-based condition monitoring of a device has, according to the disclosure, a plurality of microphones at a distance from the device. With this, a plurality of positions or components of the device that are at a distance from one another can be monitored, in that a microphone is arranged in the vicinity of each. Thus for example the condition of a pump and a motor in a hydraulic powertrain can be monitored simultaneously by the apparatus according to the disclosure, wherein a warning signal of the apparatus is output specifically for the pump or the motor.

The apparatus can be installed and initialized easily.

The microphones can be based on analog technology (e.g. piezoelectric sensors, capacitor microphone) or on micro-electro-mechanical systems (MEMS).

The apparatus is preferably self-training.

Further advantageous embodiments of the disclosure are described in the dependent claims.

Preferably at least one of the microphones has a directional characteristic or is a directional microphone. This permits interfering noises—in particular the noises of the other positions or components—to be attenuated right at the beginning of the signal chain.

It is particularly preferred for the directional microphone to comprise a rotatable or swiveling joint in order to align it to the position or component concerned.

To protect the components arranged in a primary housing from vibrations and/or waste heat from the device, it is particularly preferred for the primary housing to be arranged at a distance from the device.

For reasons of low cost and complexity of the apparatus and/or of easy mounting of the apparatus, at least one of the microphones can be arranged on the primary housing. Preferably the at least one microphone concerned is integrated into the primary housing. The primary housing can then be arranged in the vicinity of a position or component that is to be monitored. Another microphone can—in the manner of a satellite microphone—be arranged at a distance from the primary housing at another position or component that is to be monitored.

In one embodiment of the apparatus, at least one microphone is arranged in the immediate vicinity of the position or component that is to be monitored, or in its airborne-sound near-field, in order to generate a particularly clear sound signal of the component concerned.

In one embodiment of the apparatus, at least two microphones are arranged approximately on a beam that originates from the position or component, similarly to a sound-intensity probe.

In another embodiment of the apparatus, several or all microphones are arranged approximately in one plane, wherein the apparatus is designed to determine the associated position or component from transit time differences of one of the sound signals. This can in particular be done by means of the beam-forming method.

If the apparatus is fitted with a battery or an accumulator, autonomous condition monitoring of the device by the apparatus is possible. The battery or the accumulator is preferably arranged in the primary housing.

Particularly preferably an energy harvesting apparatus that can be fastened to the device or to one of the components, and which can convert the vibrations resulting, for example, from imbalance, or as a result of oscillating components such as pistons, or waste heat from the device to be monitored, into electrical energy. The energy is preferably electrical, and can be stored in the accumulator.

The primary housing can here be fastened to a low-vibration part of the device (e.g. to the vehicle frame in the case of a mobile working machine). Components of the apparatus are thereby protected in the interior of its primary housing.

An improvement in the fault detection can be achieved with a further sensor that is not based on airborne sound. This can acquire structure-borne sound, or electrical current, or temperature, or volume flow, or pressure, or movement (traveling speed, speed of rotation) or position (pivot angle, drive pedal position).

The information of the further sensor can be CAN bus information.

The monitored condition that is to be detected can be wear or cavitation or insufficient suction (of a hydrostatic pump) or wrong or incorrect installation of the components or a deviating speed of rotation of a rotating component (e.g. a drive shaft of a hydrostatic displacement machine or of a tire of a mobile working machine).

The device according to the disclosure is fitted with an apparatus, described above, for airborne-sound-based condition monitoring.

The device can be a mobile working machine or an electrical machine or a combustion engine or an auxiliary aggregate of a combustion engine (e.g. an injection system). The device can be formed of a mobile working machine or of a powertrain with one or a plurality of hydrostatic displacement machines in industrial or mobile applications, e.g. a plurality of non-central hydraulic motors on drive axes, or multiple pumps for driving or working hydraulics. The apparatus can also be a hydrostatic displacement machine or a hydrodynamic machine (e.g. a fan or impeller) or a mechanical gearbox or a hydraulic control unit.

The components to be monitored can be a displacement machine (e.g. a hydraulic powertrain) or a piston or a drive shaft (e.g. of a displacement machine) or a roller bearing (e.g. of a displacement machine or of a mechanical gearbox) or a tire (e.g. of a mobile working machine) or a hydraulic valve (e.g. of a hydraulic control unit). In the case of the hydraulic valve, cavitation or the closing and opening function, i.e. the possibility of jamming, can be monitored.

In the method according to the disclosure for airborne-sound-based condition monitoring of devices, the signals of a plurality of microphones, which were previously assigned each to a component to be monitored, are evaluated. A plurality of positions or components of the device that are distant from one another can thus accordingly be monitored. Thus for example, in a hydraulic powertrain, the condition of a pump and a motor can be monitored simultaneously with the apparatus according to the disclosure, wherein a warning signal of the apparatus is output specifically for the pump or the motor.

Preferably the method is self-training.

Preferably, an initialization of the spatial arrangement is performed prior to the condition monitoring through generating a sound signal at the respective position or component. This can, for example, be done simply through a hammer blow, or through isolated operation of the component.

To minimize the energy requirement of the apparatus used in the method, automatic activation of the apparatus through a trigger or a circuit can be carried out as required. The trigger can, for example, be an acoustic signal that is conveyed by one of the microphones. The trigger can also be a vibration signal that is detected by the additional sensor, or activated by an external control signal (e.g. CAN bus).

It is particularly preferred if interfering noises are minimized, or if the individual sound signals are isolated from interfering noises, during the condition monitoring. This can be done with a functional method (signal analysis) or with a knowledge-based method (pattern recognition).

The method can comprise a calculation or estimation of the remaining service life of the component.

### BRIEF DESCRIPTION OF THE DRAWING

An exemplary embodiment of the condition monitoring system according to the disclosure is illustrated in the FIGURE.

The FIGURE symbolically illustrates important components of a powertrain 1 of a mobile working machine (not shown in more detail). Five components of the powertrain 1 are shown by way of example, namely a drive machine 2, which can be a diesel engine or an electric motor, a transfer gearbox 4, a pump 6 implemented as an axial piston machine, and a motor 10 also implemented as an axial piston machine.

### DETAILED DESCRIPTION

The pump 6 is connected through a hydraulically closed circuit (not illustrated) to the motor 10. The circuit furthermore comprises various hydraulic valves, of which one valve 8 is shown in the FIGURE by way of example.

When the powertrain 1 is operating, the components 2, 4, 6, 8, 10 illustrated each exhibit a sound emission 12, whose characteristic depends on one or more conditions of the respective components 2, 4, 6, 8, 10. Thus, for example, when the valve body (not shown) of the valve 8 switches, it generates a specific sound which does not appear if it is jammed.

The powertrain 1 is fitted according to the disclosure with an apparatus 14 for monitoring the conditions of the components 2, 4, 6, 8, 10 on the basis of their respective sound emissions 12. For this purpose, the apparatus 14 has a primary housing 16 with five terminals 18 to each of which an external microphone 20, 22 is connected. Each microphone 20, 22 is assigned to one component 2, 4, 6, 8, 10. For this purpose, each microphone 20, 22 is arranged in the vicinity of the respective component 2, 4, 6, 8, 10, in order in particular to acquire its sound emission 12 and to convert it into a sound signal that is transmitted to the primary housing 16. The microphone 20 that is assigned to the pump 6 is here arranged in its immediate vicinity, i.e. in the airborne-sound near-field of the pump 6. The microphone 22, which is assigned to the motor 10, is formed as a directional microphone. It can be aligned, using a rotatable or swiveling joint 24, to the motor 10.

The respective sound emissions 12 are acquired according to the disclosure by the apparatus 14, and then isolated from interfering noises. This can be done by means of signal analysis or by means of pattern recognition.

If one of the condition-monitored components 2, 4, 6, 8, 10 makes a noticeable noise during operation of the powertrain 1, then this is acquired by the apparatus 14 and, in accordance with the arrow 26, reported, for example, to the driver's cab of the mobile working machine. This report to the high-level controller can be made over wires or wirelessly.

The microphone 20 that is assigned to the working machine 2 is connected wirelessly to the primary housing 16.

As a departure from the illustrated exemplary embodiment, it is also possible for one of the external microphones 20 to be omitted and to be replaced by an internal microphone that is integrated into the primary housing 16.

An airborne-sound-based condition monitoring of various components of a machine or of a system using a plurality of microphones is disclosed.

### LIST OF REFERENCE SIGNS

1 Powertrain
2 Drive machine
4 Transfer gearbox
6 Pump
8 Valve
10 Motor
12 Sound emission
14 Apparatus
16 Primary housing
18 Terminal
20 External microphone
22 External directional microphone
24 Rotatable or swiveling joint
26 Arrow

What is claimed is:

1. An apparatus for airborne-sound-based condition monitoring of a device comprising:
at least one microphone assigned to each component of a plurality of components of the device that is to be monitored.

2. The apparatus according to claim 1, wherein:
the at least one microphone includes a directional characteristic or is a directional microphone, and
the directional microphone includes a rotatable joint or a swiveling joint.

3. The apparatus according to claim 1, further comprising:
a primary housing located at a distance from the device.

4. The apparatus according to claim 3, wherein:
the at least one microphone is arranged on the primary housing, and/or
the at least one microphone is located at another distance from the primary housing.

5. The apparatus according to claim 1, wherein the at least one microphone is arranged in the immediate vicinity or in the airborne-sound near-field of the corresponding component of the plurality of components to which the at least one microphone is assigned.

6. The apparatus according to claim 1, wherein:
the at one microphone includes at least two microphones arranged approximately along a beam that originates from the corresponding component of the plurality of components to which the at least two microphones are assigned.

7. The apparatus according to claim 1, wherein:
the at least one microphone is arranged approximately in one plane, and
the apparatus is configured to determine the corresponding component of the plurality of components to which the at least one microphone is assigned from transit time differences of a sound signal.

8. The apparatus according to claim 1, further comprising:
an energy-harvesting apparatus fastened to the device and configured to convert vibrations or heat of the device into electrical energy.

9. The apparatus according to claim 4, further comprising:
a decomposed structure, in which the at least one microphone is configured as a satellite microphone with integrated electronics.

10. The apparatus according to claim 9, wherein the satellite microphone is implemented with energy independence and includes a battery, an accumulator, and/or an energy-harvesting apparatus configured to convert vibrations or heat of the device into electrical energy to power the satellite microphone.

11. The apparatus according to claim 10, wherein:
an electronic design of the primary housing or of a primary device and of the satellite microphone are of identical construction, and
the apparatus further includes a wireless data transmission device and a further sensor.

12. The apparatus according to claim 1, wherein the airborne-sound-based condition is cavitation, insufficient suction, wrong or incorrect installation of the plurality of components, or a deviating speed of rotation.

13. A system comprising:
a device including a plurality of components; and
an apparatus for airborne-sound-based condition monitoring of the device, the apparatus comprising at least one microphone assigned to each component of the plurality of components of the device.

14. The system according to claim 13, wherein:
the device includes a mobile working machine, a powertrain, a hydrostatic gearbox, one or a plurality of hydrostatic displacement machines, an electrical machine, a combustion engine, a hydrodynamic machine, a mechanical gearbox, or a hydraulic control unit, and
the plurality of components includes a hydrostatic displacement machine, an auxiliary aggregate of a combustion engine, a drive shaft, a roller bearing, a piston, a tire, or a valve.

15. A method for airborne-sound-based condition monitoring of a device including a plurality of components, comprising:
assigning at least one microphone to each component of the plurality of components of the device; and
evaluating sound signals of the assigned at least one microphone.

16. The method according to claim 15, further comprising:
initializing through generating a sound signal at at least one component of the plurality of components.

17. The method according to claim 15, further comprising:
automatically activating the condition monitoring through a trigger.

18. The method according to claim 15, further comprising:
minimizing interfering noises during the condition monitoring; or
insulating the sound signals from the interfering noises during the condition monitoring.

19. The method according to claim 15, further comprising:
calculating or estimating a remaining service life of at least one component of the plurality of components.

20. The method according to claim 15, further comprising:
localizing at least one component of the plurality of components with a beam-forming method.
